(19) United States
(12) Patent Application Publication
(10) Pub. No.: US 2008/0217905 A1
(43) Pub. Date: Sep. 11, 2008

(54) ADVERTISING PROGRAM USING PLAYING CARDS

(76) Inventor: W. Paul Allison, Jenks, OK (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/034,068

(22) Filed: Feb. 20, 2008

Related U.S. Application Data
(60) Provisional application No. 60/891,059, filed on Feb. 22, 2007.
(60) Provisional application No. 60/977,100, filed on Oct. 3, 2007.

(51) Int. Cl. B42D 15/00; G06Q 30/00

(52) U.S. Cl. 283/56; 705/14

(57) ABSTRACT

An advertising method and system in which playing cards include advertisements for products. The hierarchical value of the cards and the price range of the advertised products are preferably generally correlated so that higher-value cards have advertisements for higher-value products and lower-value cards have advertisements for lower-value products. Also, the hierarchical value of the cards and the prices of the advertisements are preferably generally correlated so that the advertisements on the higher-value cards cost more than the advertisements on the lower-value cards. In addition, prize cards can be randomly distributed among a number of the decks. Furthermore, a building or building compound can include a casino using the cards and a retail outlet selling the products advertised on the cards. Moreover, the cards may feature a casino and be used and sold in that casino, and/or the cards may feature a celebrity whether affiliated with the casino or not.

### CROSS-REFERENCE TO RELATED APPLICATIONS

This application claims the priority benefit of U.S. Provisional Patent Application Ser. No. 60/977,100, filed Oct. 3, 2007, and U.S. Provisional Patent Application Ser. No. 60/891,059, filed Feb. 22, 2007, the entire scope and content of which are hereby incorporated herein by reference.

### FIELD OF THE INVENTION

The present invention relates generally to advertising programs and, in particular, to an advertising system and method using playing cards.

### BACKGROUND OF THE INVENTION

Luxury companies compete throughout the world and spend millions of dollars yearly in advertising their luxury items through a range of outlets. Such luxury goods and services may include yachts, airplanes, jewelry, golf clubs, perfume, sports cars, motorcycles, and so on. So consumers may be exposed to many advertisements for luxury items every day via the Internet, radio, billboards, magazines, television, and so on. Therefore, successful global luxury companies with well-established brands have large advertising budgets in place and are in need of a new form of advertising to increase their brand exposure.

Accordingly, it can be seen that needs exist for new and innovative ways of advertising to consumers. It is to the provision of such solutions that the present invention is primarily directed.

### SUMMARY OF THE INVENTION

Generally described, the present invention provides an advertising method and system in which playing cards include advertisements for products. Decks of the playing cards are provided for advertising use by a branded entity such as a casino or celebrity. And the advertisements are for products (or the providers thereof) of common purchasing interest to patrons of the casino or other branded entity. Preferably, a trademark of the casino, celebrity, or other branded entity is placed on the back sides of the cards, and the advertisements are placed on the front sides of the cards, with the branded entity being different from the manufacturers, advertisers, and sellers of the products features on the advertisements.

In one aspect of the invention, the hierarchical values of the cards and the price ranges of the advertised products are preferably generally correlated so that higher-value cards have advertisements for higher-priced products and lower-value cards have advertisements for lower-priced products. In addition, the general correlation between the product prices and the hierarchical card values can be based on groups of the cards so that the price for the products on a higher-value group of the cards is higher than on a lower-value group of the cards.

In another aspect of the invention, the advertisement prices and the hierarchical values of the cards are preferably correlated so that the advertising price for the advertisement on a higher-value one of the cards is higher than on a lower-value one of the cards. In addition, the correlation between the advertisement price ranges and the hierarchical card values can be based on groups of the cards so that the advertising price range for the advertisements on a higher-value group of the cards is higher than on a lower-value group of the cards.

In yet another aspect of the invention, categories of the products are correlated to the card values or suits so that all the advertisements for all the products within one of the product categories are placed on the cards having the correlated value or suit. For example, the product categories can include all brands of one type of a product, or all the products sold under one particular brand.

In still another aspect of the invention, one or more prize cards are randomly inserted into the decks of playing cards. The prize cards include win/lose indicia that indicates if a prize has been won. The prizes are preferably products that are included in the advertisements on the playing cards.

In but still another aspect of the invention, a themed building compound is provided, with the compound including one or more buildings and the theme coordinated with the casino or other branded entity. The themed compound may include a casino at which the playing cards are used, a retail outlet at which the products of the advertisements on the playing cards are sold, and/or a restaurant with display screens showing advertisements of the same products.

And in another aspect of the invention, there are provided decks of the playing cards including the advertisements described herein. The card decks can be used at the casino, sold at the casino, and/or distributed and sold through outlets other than the casino.

The specific techniques and structures employed by the invention to improve over the drawbacks of the prior art and accomplish the advantages described herein will become apparent from the following detailed description of the example embodiments of the invention and the appended drawings and claims.

### BRIEF DESCRIPTION OF THE DRAWINGS

FIG. 1 is a perspective view of a deck of playing cards according to an example embodiment of the present invention.

FIG. 2 is a back side view of one playing card of the deck of FIG. 1, showing a casino trademark marked on the card.

FIG. 3 is a front side view of four playing cards of the deck of FIG. 1, showing advertisements for luxury products marked on the cards.

FIG. 4 is a front side view of one playing card of the deck of FIG. 1, showing an example layout of the advertisements.

FIG. 5 is a front side view of three playing cards of the deck of FIG. 1, showing example advertisements for commercially available automobiles according to the layout of FIG. 4.

FIG. 6 is a front side view of three prize cards, any of which may be inserted into the deck of FIG. 1.

FIG. 7 is a perspective view of the front of a building including a casino where the cards are used and a retail outlet where the products advertised on the cards are sold.

FIG. 8 is a plan view of the first floor of the building of FIG. 7.

FIG. 9 is a back side view of a playing card of a deck according to another example embodiment of the present invention.

FIG. 10 is a perspective view of a point-of-purchase display fixture for decks of the cards of FIG. 9.

### DETAILED DESCRIPTION OF EXAMPLE EMBODIMENTS OF THE INVENTION

The present invention provides advertising methods and systems using playing cards. Decks of playing cards are provided for advertising use by a branded entity such as a casino or casino chain, and advertisements are placed on the playing cards. The advertisements are for goods or services, or the providers thereof, commonly used or purchased by, or that might be of interest to, typical patrons of the casino (or other branded entity). Thus, the advertisements are typically but not necessarily for luxury products. As used herein, “casino” means any place of gaming where card games such a poker, blackjack, baccarat, etc. are played and includes casino chains, “products” means “goods and/or services,” “common purchasing interest” means commonly used or purchased by, or that might be of interest to, a substantial portion of typical patrons of a casino or other branded entity, and “patrons” means customers, clients, supporters, fans, etc.

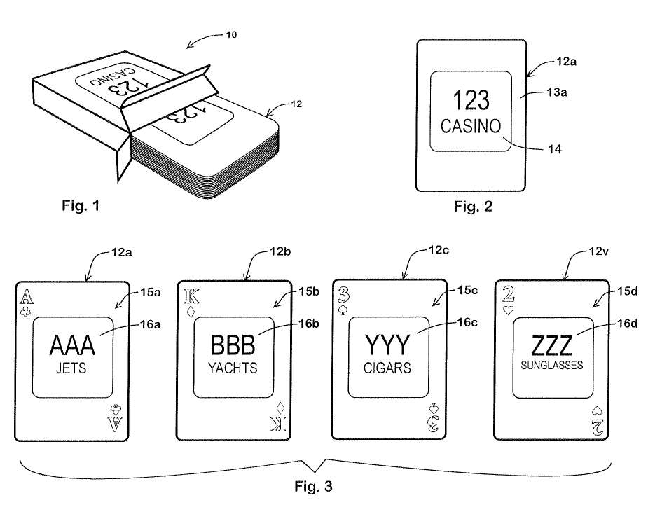

FIG. 1 shows a deck 10 of playing cards 12 according to an example embodiment of the present invention. In a typical commercial embodiment, the deck 10 is a standard fifty-two-card deck of playing cards with thirteen card values (deuce through ace) each provided in four suits (hearts, diamonds, clubs, and spades). In alternative embodiments, the decks can be provided in other configurations (e.g., other card values, number of cards, or suits) as may be desired for new and/or non-traditional types of card games. FIG. 2 shows one card 12a of the deck 10, with the trademark (i.e., name, logo, or both) 14 of the branded casino or casino chain marked on the back side 13a of the card. And FIG. 3 shows four cards 12a, 12b, 12c, and 12d of the deck 10, with advertisements 16a, 16b, 16c, and 16d for luxury products of common purchasing interest to patrons of the casino marked on the front sides 15a, 15b, 15c, and 15d of the cards. As discussed herein, the cards 12a, 12b, 12c, 12d, etc. are sometimes collectively or generally referred to as “the cards 12,” the card back sides 13a, etc. are sometimes collectively or generally referred to as “the back sides 13,” the card front sides 15a, 15b, 15c, 15d, etc. are sometimes collectively or generally referred to as “the front sides 15,” and the advertisements 16a, 16b, 16c, 16d, etc. are sometimes collectively or generally referred to as “the advertisements 16.”

According to one aspect of the invention, the advertised-product price ranges and the hierarchical values of the cards 12 (e.g., a king beats a ten) are generally correlated so that higher-priced products are advertised on higher-value cards and lower-priced products are advertised on lower-value cards. As can be seen in FIG. 3, for example, the ace-of-clubs card 12a bears an advertisement 16a for jets, whereas the two-of-hearts card 12d bears an advertisement for sunglasses, because aces are higher in value than deuces (in most gaming) and jets are more expensive to purchase (and maintain) than sunglasses. Similarly, the king-of-diamonds card 12b bears an advertisement 16b for yachts, whereas the three-of-spades card 12c bears an advertisement 16c for cigars, because kings are higher in value than treys (in most gaming) and yachts are more expensive than cigars.

It will be understood that this general correlation is not necessarily absolute. For example, the advertisement 16a on the ace-of-clubs card 12a could be for a line of jets and the advertisement 16b on the king-of-diamonds card 12b could be for a line of yachts, with the high-end of the yacht product line being more expensive than the low-end of the jet product line. In addition, the sunglasses of the advertisement 16d on the two-of-hearts card 12d could be high-end sunglasses costing more than one of the cigars of the advertisement 16c on the three-of-spades card 12c but not more than a box of the cigars. Furthermore, a six-value card could include an advertisement for a product that is slightly more expensive than a product in an advertisement on a seven-value card. This may be the case because, for example, pricing may vary by region, seasons, exchange rates, local taxes, etc. Moreover, six-value cards could be reserved for one category of products and five-value cards reserved for a different and generally lesser-priced category of products, with the general correlation applying to the six-value and five-value cards of each suit, but with the five card of one suit advertising a slightly higher-priced product than the six card of a different suit. Accordingly, the general correlation between the advertised-product prices and the hierarchical values of the cards is substantial but does allow for exceptions due to, for example, overlapping price ranges, differences in the quantities of typical purchases, pricing variations, and other exceptions as long as they are insubstantial in frequency.

Additionally or alternatively, the correlation between the advertised-product prices and the hierarchical values can be based on groups of cards. Thus, a group of lowest-value cards (e.g., deuce through five) can be reserved for one or more advertised products or product categories having a lowest price range, a group of middle-value cards (e.g., six through nine) can be reserved for one or more advertised products or product categories having an intermediate price range, and a group of high-value cards (e.g., ten through ace) can be reserved for one or more advertised products or product categories having a highest price range. For example, a predetermined group of high-value cards can be reserved for advertising jets, yachts, sports cars, motorcycles, and/or jewelry, while a predetermined group of intermediate-value cards can be reserved for advertising shoes, handbags, luggage, and perfume. Thus, the products advertised on the group of high-value cards cost more than the products advertised on the group of intermediate-value cards.

In another aspect of the invention, the prices charged to the advertisers for the advertisements 16 (though not necessarily the prices of the advertised products) can be correlated to the hierarchical values of the cards 12 so that the advertisement rates are higher for higher-value cards and lower for lower-value cards. For example, in order to have its yacht advertisement 16b placed on a higher-value card such as the king-of-diamonds card 12b instead of a lower-value three-of-spades card 12c, the advertiser pays a higher price for this premium advertising space.

Additionally or alternatively, the correlation between the advertisement prices and the hierarchical values can be based on groups of cards. Thus, a group of lowest-value cards (e.g., deuce through five) can have a lowest advertisement price, a group of middle-value cards (e.g., six through nine) can have an intermediate advertisement price, and a group of high-value cards (e.g., ten through ace) can have a highest advertisement price.

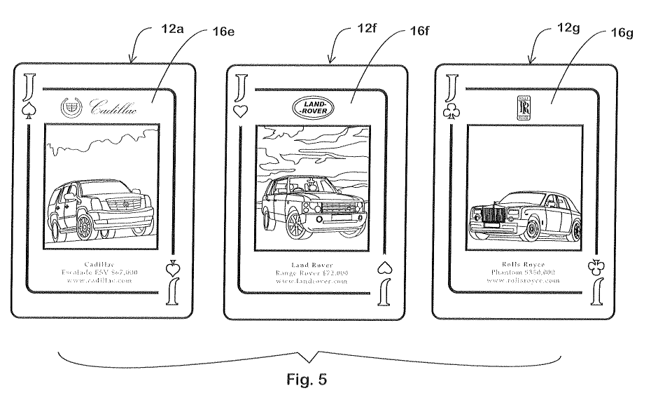

According to yet another aspect of the invention, a category of advertised products can be correlated to predetermined card values and/or suits. For example, advertisements 16c for cigars can be assigned to the three-value cards of all four suits, of only the red suits (hearts and diamonds), or of only the black suits (clubs and spades). Similarly, advertisements for automobiles can be assigned to jacks (e.g., see FIG. 5) so that the only cards with advertisements for cars are jacks and all the jacks cards have advertisements for cars. Alternatively or additionally, one brand of products can be advertised on all cards of the same value regardless of their suits, for example, one brand of automobiles can be advertised on all the ten-value cards in the deck, with the same advertisement on all four cards or with a different vehicle model by the same manufacturer on each of the four cards. Furthermore, an entire suit (e.g., all cards of the hearts suit) can be reserved for a single brand that is used on a wide range of products. Moreover, one category or theme of advertised products can be correlated to one suit of the cards. For example, advertisements for jewelry can be assigned to cards of the diamonds suit, or advertisements for romance-themed products (e.g., exotic flowers, jewelry, lingerie, perfume, weekend getaways at resorts, etc.) can be assigned to cards of the hearts suit.

In a typical commercial embodiment the playing card deck 10 includes fifty-two cards 12 (not counting jokers) each bearing one advertisements 6, so the deck includes fifty-two advertisements. In alternative embodiments, the deck 10 includes more than fifty-two advertisements 16, for example, with multiple advertisements placed on one or more of the cards or with advertisements placed on the joker cards. In addition, the deck 10 may include more advertisers than advertisements (e.g., fifty-two advertisements 16 with more than fifty-two advertisers), for example, by cross-advertising (combining multiple products into a single advertisement), where synergy permits it. And in other alternative embodiments, the deck 10 includes less than fifty-two advertisements 16, for example, with not every card including an advertisement. In addition, the deck 10 may include fifty-two advertisements 16 with less than fifty-two advertisers, for example, with the same advertiser having the same advertisement on multiple cards in the same deck (e.g., all jack cards include the identical advertisement) or with the same advertiser having the different advertisements for the same or different products on multiple cards in the same deck.

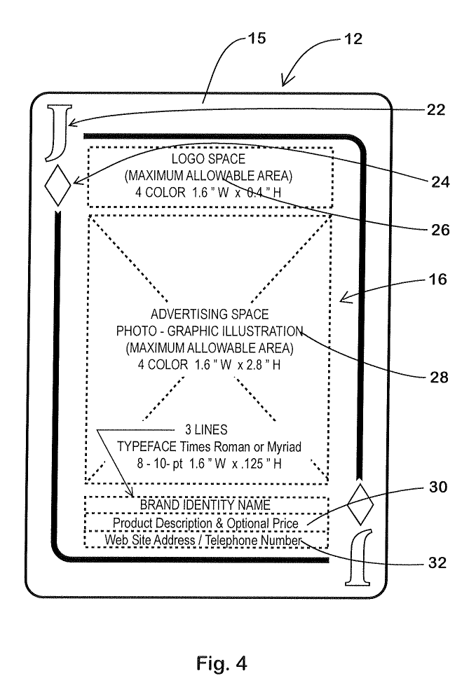

FIG. 4 illustrates an example layout of the front side 15 of the cards 12 of the deck 10 of a typical commercial embodiment. Each card 12 includes the number/face symbol 22 and the suit symbol 24 of the card, as is standard on playing cards. The advertisement 16 on the card 12 may include the advertiser's trademark (e.g., name and/or logo) 26, an image (e.g., photo or illustration) 28 of the advertised product, information (e.g., name, brief description, slogan, and/or price) about the advertised product, and/or the advertiser's contact information (e.g., phone number and/or website address) 32. The dimensions shown in the figures for the components of the advertisement 16 are included for illustrative purposes only and may be modified as desired. In alternative embodiments such as in electronic-rendered representations of cards displayed on television, computer, or game machine screens, the advertisements may include only the advertiser's name or trademark.

FIG. 5 illustrates examples of this layout with advertisements 16e, 16f, and 16g for three different luxury automobiles on the front sides of three jack cards 12e, 12f, and 12g. (The trademarks and any copyrighted works shown in FIG. 5 are the property of their respective owners and are included for illustrative purposes only without any claim of ownership, and the example embodiments of the invention described in this patent application are in no way sponsored by or affiliated with the trademark owners.) Typically, the manufacturers, advertisers, and sellers of the products in the advertisements 16 on the front sides of the cards 12 are different entities from the casino who advertises by placing its trademark on the back sides of the cards.

In addition to the cards 12 being used by and in casinos, the card decks 10 can be sold at point-of-purchase locations in the casinos or at other outlets. Such other outlets may include convenience stores, gas stations, newsstands, bookstores, retail outlets, department stores, game and novelty stores, playing card distributors, and other retail businesses. In addition, the decks 10 can be sold online or by mail order. For example, the card decks 10 can be sold in periodic subscriptions (e.g., a one-year, twelve-deck subscription).

Cards used in casinos tend to wear out due to their high use, so new playing card decks 10 are regularly printed. This provides the opportunity to place some or all different advertisements 16 on the cards 12 for featuring different advertisers and/or to permit the same advertisers to include new advertisements under new and/or seasonal advertising campaigns. For example, new decks 10 of the cards 12 can be printed for the spring, summer, fall, and winter holiday seasons, with the spring cards featuring black and gold colors, the summer cards featuring red and blue colors, the fall cards featuring orange and maroon colors, and the winter holiday cards featuring red and green colors. Similarly, packaging for the cards 12 and advertising materials (e.g., ads in magazines, posters in stores where the decks can be purchased, point of purchase displays) can be changed by season and feature the same color schemes. For example, the spring advertising materials may include imagery of formal wear, the summer advertising materials may include imagery of the American flag, the fall advertising materials may include imagery of fallen leaves, and the winter holiday advertising materials may include imagery of Santa Claus. The card deck printing can be run on a monthly, yearly, or other regular or irregular basis.

The advertising method can be carried out by the casino itself or by a third party on its behalf. Thus, a third-party affiliate can publish or have published the card decks 10, their packaging, and advertising materials (point-of-purchase display fixtures, posters, advertisements, etc.) as part of the program. In addition, the third-party affiliate can also publish or have published promotional coupons, coupon books, gift cards, and/or gift certificates that can be redeemed for discounts on the purchase of the advertised products.

Sample distribution, organizational sales, and direct mail to targeted lists of gambling, travel, and entertainment advertisers can be utilized to attract the advertisers. In addition, the cards 12 can be marketed via direct marketing and through established mail order catalogues and gaming distribution channels such as hotel convenience stores and branded stores within a hotel or casino mall. The advertising program is designed to produce high profits and high margins. The advertising program preferably includes mass marketing, for example, the program may include a highly focused multi-dimensional sales and tiered marketing plan to build the total branding and circulation base quickly. In addition to advertising, direct mail, and media executions, public relations exposure will benefit card circulation significantly. The advertising program can be implemented in only one or a few geographical areas, for example, casinos based in New Jersey and Las Vegas. Or it can be implemented nationally and used in all casinos nationwide or internationally.

The cards 12 are preferably printed on high-quality card stock with a glossy plastic coating that is resistant to marks and damage. The cards 12 preferably have a contemporary look and appeal and include high-quality art content. For example, the back sides 13 of the cards 12 may have a textured or velvet/satin varnish finish. The cards 12 are preferably refined, entertaining, and easy to recall, they can even be thought-provoking, and they appeal to a broad and diverse range of advertisers and card players.

The decks 10 can be customized into men's decks and women's decks, with the men's cards 12 including advertisements 16 for male-oriented products and the women's cards including advertisements for female-oriented products. Example advertised-product categories for men include but are not limited to motorcycles, sailboats, cigars, wines, electronics, sports cars, colognes, shoes, suites, watches, airplanes, resorts, yachts, golf clubs, cruise lines, hotels, golf courses, ties, credit cards, cell phones, belts, cufflinks, pens, champagnes, artwork, grills, and golf clubs. Example advertised-product categories for women include but are not limited to perfumes, cosmetics, sports cars, jeans, cell phones, gloves, scarves, pants, jewelry, shoes, rings, wedding and evening gowns, lingerie, necklaces, lipstick, swimsuits, spas, resorts, IPODS, and so on. Each category of products can correspond to a particular card value, with the hierarchical card values and the advertised-product prices generally correlated, as is illustrated by the following example:

| Card | Product Category (Men) | Product Category (Women) |
|---|---|---|
| Deuces | cologne | perfume |
| Threes | cigars | jeans |
| Fours | wines | lingerie |
| Fives | dress shoes | swimsuits |
| Sixes | televisions | cell phones |
| Sevens | suites | sunglasses |
| Eights | watches | dresses |
| Nines | grills | purses |
| Tens | motorcycles | shoes |
| Jacks | sports cars | watches |
| Queens | airplanes | necklaces |
| Kings | sailboats | earrings |
| Aces | yachts | engagement rings |
| Jokers | sunglasses or cell phones | bedroom sets or sports car |

If desired, the men's decks and the women's decks can have the same advertised-product categories for the same card values.

Conventional playing cards are typically not associated with luxury products and are not sold in retail outlets associated with luxury products, but instead are typically sold in game and convenience stores where they are positioned next to for example magazines. The playing cards 12 of the present invention, on the other hand, advantageously provide luxury companies with a new way to advertise their finest luxury products and also allow them to be associated with upscale casinos and/or celebrities. In particular, the decks 10 of playing cards 12 can each include advertisements 16 for fifty-two or more luxury products by fifty-two or more worldwide luxury companies. For example, high-end companies that may advertise under the program include BMW, MERCEDES, PORSCHE and FERRARI automobiles, CABO and TRINITY YACHTS, GULFSTREAM and LEAR jets, ROLEX, CARTIER, and TAG HEUER watches and/or jewelry, LOUIS VUITTON, GUCCI, KATE SPADE, and COACH handbags, DIOR, MONOLO BLAHNIK, and PRADA shoes, etc. No one is known to have brought high-end companies together and advertised their luxury companies and products in a deck of playing cards, not just advertising one product and one company, but many companies and many products of varying types, with the finest luxury companies in the world competing for the advertisement spaces, with the cards used in casinos and otherwise provide to targeted customer who tend to purchase such high-end products.

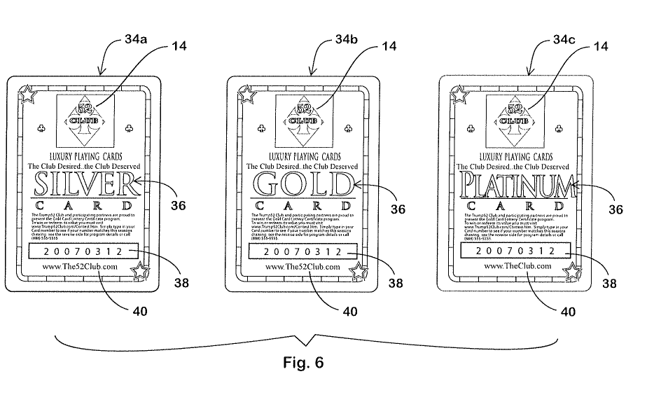

In another aspect of the invention, one or more prize cards are placed randomly throughout all of the decks 10 available for purchase within a predetermined time period and/or region. No more than one prize card is included in any one deck, and the decks are packaged and sealed so that it is readily apparent it they have been opened prior to purchase. FIG. 6 illustrates three prize cards 34a, 34b, and 34c (collectively, the “prize cards 34”), each including the casino trademark 14, of a typical commercial embodiment. The prize cards 34 each include a win/lose indicia 38, for example, a code number as is depicted. When a patron at a casino is dealt (or otherwise receives) one of the prize cards 34, the patron can then present the card to the casino for redemption for the corresponding prize. This can be done by physically presenting the card 34 to casino personnel or by accessing a website and entering the code 38, with the website then displaying an indication (e.g., an image or description) of what prize has been won and instructions for receiving the prize. Thus, the prize cards 34 may have the website address 40 marked on them. Alternatively, the win/lose indicia 38 may be provided by an indication (e.g., an image or description) of what prize has been won, preferably with the indication covered by a scratch-off layer so that it is obscured until the scratch-off layer is removed.

Preferably, the prizes are luxury products that have been included in the advertisements 16 on the cards 12 in the same deck 10 with the prize card 34. Thus, the prizes can be, for example, jewelry, fashion handbags, a timeshare in a coveted location, a trip to a luxury resort, or a chance to win one of these. Alternatively, the prizes can be correlated to celebrities, preferably celebrities who are included in the advertisements 16 on the cards 12. For example, the prizes can be autographs and/or photographs of celebrities, with the autographed photographs placed on the cards 34 themselves or redeemable by presenting the winning cards. Or the prizes can include merchandise bearing the image and/or autograph of the celebrity (e.g., clothing, framed posters), discounts to celebrity-owned or celebrity-themed hotels/resorts, etc.

In addition, the prize cards 34 may include prize-level indicia 36 that correspond to the value of the prizes. For example, the three cards 34a, 34b, and 34c have prize-level indicia 36 of “silver,” “gold,” and “platinum,” with the prize won by the recipient of the platinum card being of higher value than the prize won by the recipient of the gold card, which is of higher value than the prize won by the recipient of the silver card. In addition, the cards 34 can be color-coded to match the prize-level indicia, for example, the silver prize-level card 34a can be silver in color. The platinum-level prizes are extremely upscale (e.g., a new car), so few of these cards 34c are inserted into the decks 10 and therefore they are very difficult to come across. The gold-level prizes are less expensive than the platinum-level prizes (e.g., a timeshare), so more of these cards 34b are inserted into the decks 10 than platinum-level cards 34c. Similarly, silver-level prizes are less expensive than the gold-level prizes (e.g., a handbag), so more of these cards 34a are inserted into the decks 10 than gold-level cards 34b. Alternatively, a bronze level may be included as well for prizes with values less than those of the silver-prize level.

The prize cards 34 represent an effective promotional method in generating market appeal and excitement toward the playing cards 12. Including the prize cards 34 in random decks 10 of cards 12 encourages individuals to purchase the cards because consumers will have the opportunity to win upscale merchandise and giveaways.

In still another aspect of the invention, there is provided a themed building compound including one or more casinos as well as restaurants and cafes, fashion and merchandise outlets and/or showrooms, and/or music and entertainment venues, etc. The themed compound may be a single building structure or a complex of buildings configured into an integral facility. The compound has a theme that is coordinated with the branded entity (a casino, celebrity, etc.).

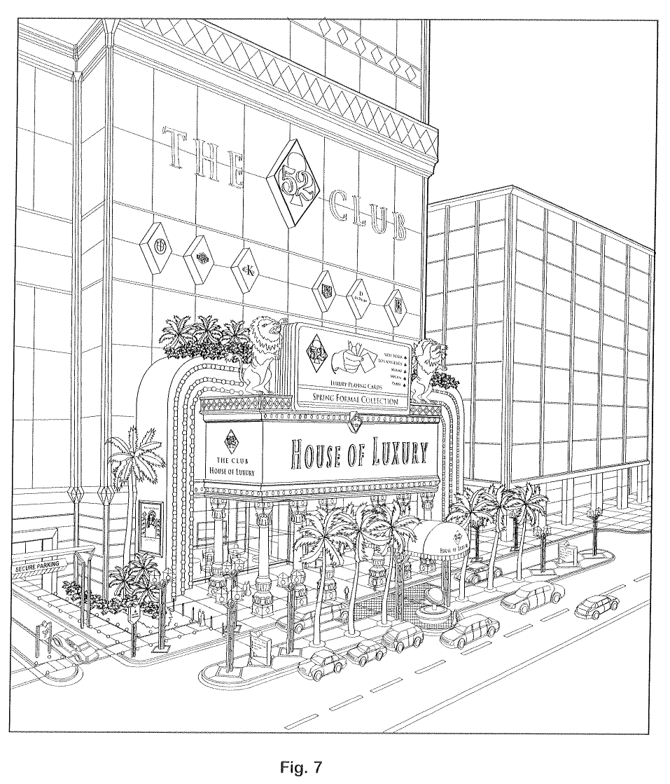

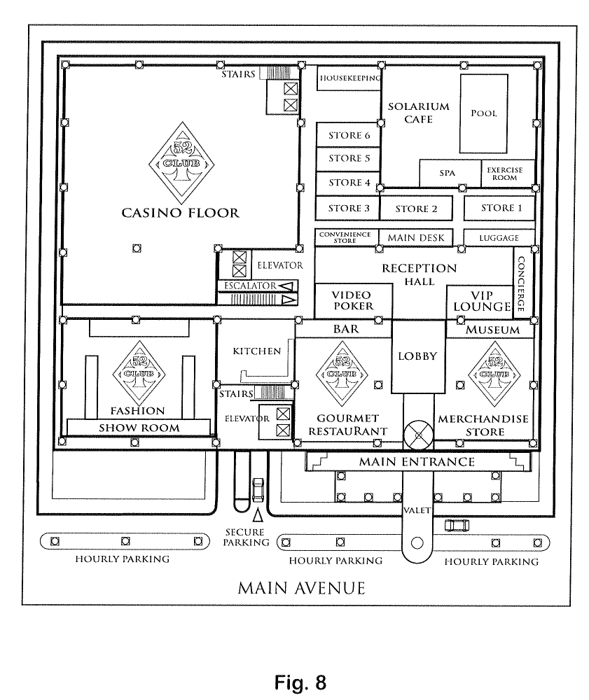

FIGS. 7 and 8 show example aspects of one such themed building compound 42, which may be referred to as the “House of Luxury.” The themed compound 42 includes a casino 44 in which the playing cards 12 are used. In addition, the themed compound 42 preferably includes one or more retail outlets (stores, kiosks, sales displays, etc.) 46 that sell the products in the advertisements 16 on the cards 12 used in the casino 44 (or they sell at least some of the products that can be practically be sold there—products such as timeshares and jets might not be practically sold there). The retail outlets 46 can also sell the card decks 10 themselves, House of Luxury-branded products, and/or the prizes that are won with the prize cards 34. Furthermore, the themed compound 42 may include dedicated stores 47 for selling a single brand of products that are included in the advertisements 16 on the cards 12.

The themed compound 42 may also include one or more showrooms 48 that can be set up for multiple uses. For example, the showroom 48 can be set up for use as a fashion or product showroom for promoting (e.g., by holding fashion shows) clothing, jewelry, and/or other products that are included in the advertisements 16 on the cards 12. The showroom 48 can also be set up for use as an entertainment venue for holding a poker tournament, such as a celebrity poker event, in which the cards 12 are used. Or the showroom 48 can be set up for use as a conventional hall for a conventional at which one or more of the advertisers are primary sponsors. In addition, the showroom 48 can also be set up as a ballroom for dinners, wedding receptions, live music events, etc.

In addition, the themed compound 42 may include one or more restaurants 50, as well as guest rooms, an exercise room, a spa, and other amenities typical of hotels and resorts. The restaurants 50 and other areas of the themed compound may include display screens (e.g., flat panel televisions) on which advertisements for the products are displayed. These advertisements can be the same advertisements 16 (still images) that are on the cards 12, regular television advertisements (video and audio) for the same products, or specially made advertisements for the same products.

In alternative embodiments, the building compound has a theme that is coordinated with a celebrity but not a casino. In such an embodiment, the building compound includes at least one of the fashion and merchandise outlets and/or showrooms, at least one of the restaurants and/or cafes, and/or at least one of the music and entertainment venues. The themed compound need not include a casino, and as such it can be built in an area where gaming is not legal to still implement the advertising method to the benefit of the celebrity.

According to another aspect of the invention, there is provided a club whose members are the patrons of the casino and the advertisers on the cards 12. The cards 12 are primarily intended for advertisements 16 by advertisers who are attempting to reach high discretionary income customers at many levels. The advertising program can thus be a marketing vehicle for advertisers whose products represent high class and luxury in the marketplace. By advertising on the cards 12, the advertisers are better able to inform casino customer club members and other advertiser club members about their new luxury products available exclusively or non-exclusively to members of the club.

It is contemplated that, in addition to being implemented by using physical playing cards, the present invention can be implemented using virtual playing cards displayed on display screens such as on televisions, computer monitors, arcade games, etc. For example, poker tournaments (e.g., the WORLD SERIES OF POKER) are often televised, and the cards 12 can be used in such tournaments. (In fact, such tournaments can be held and televised from the ballroom 50 of the House of Luxury building 42.) In addition, the television broadcasts typically display representations of the cards of each players hand for viewing by the spectators watching on a television screen. In addition, online gaming sites and arcade games include poker games in which representations of the cards of each player's hand are displayed on the screen of the computer monitor or game machine. Accordingly, the terms “cards” as used herein is intended to be broadly construed to include physical cards as well as electronic-rendered representations of cards on display screens.

Having described certain aspects of the invention, a specific example advertising method and system will now be described to highlight these and other aspects of the invention. It will be understood that this example is included for illustrative purposes only, and that the scope of the invention is not limited to this specific advertising method.

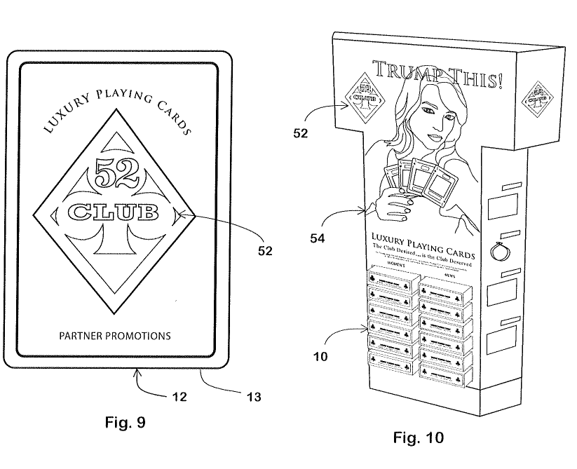

In an example embodiment, the invention includes an advertising method and system using the playing cards described herein and leveraging the TRUMP hotel and casino empire. (The word “TRUMP” is a registered trademark of Donald J. Trump of New York, N.Y., the mark is used herein for illustrative purposes only without any claim of ownership, and the example embodiments of the invention described in this patent application are in no way sponsored by or affiliated with Mr. Trump.) As shown in FIG. 9, in one aspect the invention provides playing cards 12 having back sides 13 bearing a TRUMP-based trademark 52 and front sides bearing advertisements as described herein. And as shown in FIG. 10, in another aspect the invention provides advertising materials such as point-of-purchase display fixtures 54 that hold the card decks 10 and that have the TRUMP-based trademark 52 marked thereon.

The cards 12 are used as a promotional tool within the international TRUMP hotel and casino industry to attract sales and advertising partners, thereby turning the expense of card decks into a profitable business. The advertising method and system takes advantage of the far-reaching TRUMP building, hotel, casino, gaming, retail, product, and media channels to help its existing partners, customers, and brand retailers by offering instant and repeated exposure to card players through advertisements for products printed directly on the playing cards 12 used in the casinos. The decks 10 are used in the TRUMP casinos and sold at point-of-purchase locations throughout the entire TRUMP hotel and casino network or anywhere else that cards are sold and/or card games are played.

It will be understood that this specific example is provided for illustration purposes only and that the present invention can be implemented in many other ways. For example, the advertising method and system can be implemented by or on behalf of a casino or casino chain such as HARRAH'S (including BALLY'S, CAESAR'S PALACE, HARRAH'S, FLAMINGO, etc.), LAS VEGAS SANDS (THE VENETIAN, THE PALAZZO, SANDS MACAO, MARINA BAY SANDS, etc.), WYNN RESORTS (WYNN LAS VEGAS, WYNN MACAU), MGM MIRAGE (BEAU RIVAGE, BELLAGIO, LUXOR, MGM GRAND, MANDALAY BAY, THE MIRAGE, etc.), and/or PENN NATIONAL GAMING (EMPRESS JOLIET, HOLLYWOOD BATON ROUGE, AND ARGOSY RIVERSIDE). (The recited trademarks are owned by their respective owners and are used herein for illustrative purposes only without any claim of ownership, and the example embodiments of the invention described in this patent application are in no way sponsored by or affiliated with the trademarks owners.) In these cases, trademark of the casino or casino chains is preferably included on the back side of the cards.

According to another aspect of the invention, the playing cards 12 feature a different branded entity (other than a casino) such as a celebrity. This can be done in addition to or as an alternative to the invention being implemented by or on behalf of a branded casino/chain. That is, in cases where a celebrity (e.g., DONALD TRUMP or STEVE WYNN) is known to have a sponsorship or other relationship with a casino/chain, then both the celebrity and the casino can be promoted by the cards. And in cases where a celebrity (e.g., OPRAH WINFREY, TIGER WOODS, P. DIDDY, RICHARD BRONSON) is not known to have a relationship with a casino/chain, then only the celebrity is promoted by the cards. (The recited trademarks are owned by their respective owners and are used herein for illustrative purposes only without any claim of ownership, and the example embodiments of the invention described in this patent application are in no way sponsored by or affiliated with the trademarks owners.) The celebrity can be featured on the cards 12 for example by including the name and/or image of the celebrity on the back side of the cards 12 (where the casino trademark would otherwise go), on the front side of the cards (12 where one of the advertisements would otherwise go), and/or on packaging and advertising materials. For example, the ace-of-clubs card can include an autographed photograph of the celebrity or a photograph of the celebrity posed in front of or using certain of the advertised products (in place of where an advertisement would ordinarily be placed), while the other cards in the deck include the advertisements described herein. In cases where the celebrity is promoted by the cards 12 (regardless of whether a casino is also promoted by the cards), the advertisements 16 can be primarily or exclusively for products of interest of typical fans of the sponsor. For example, card decks 10 featuring OPRAH WINFREY can feature advertisements for products of particular interest to women, card decks 10 featuring TIGER WOODS can feature advertisements for products of particular interest to golfers, and card decks 10 featuring P. DIDDY can feature advertisements for products of particular interest to hip-hop music enthusiasts.

In another example embodiment of the invention, the cards have one of the advertisements placed on the back sides of the cards, where the casino, celebrity, or other branded entity's trademark would otherwise be. This can be in addition to or instead of placing the advertisements on the front sides of the cards. The same advertisement is placed on all of the cards of one deck, with different decks having different advertisements. In this way, the other players at the card table can view the advertisements.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be unnecessarily limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. An advertising method for a branded entity, comprising:
providing a plurality of playing cards; and
placing advertisements on one or more of the playing cards, wherein the advertisements are for products or providers thereof of common purchasing interest to patrons of the branded entity.

2. The advertising method of claim 1, wherein the plurality of cards comprises a deck of cards.

3. The advertising method of claim 1, wherein the branded entity is a casino, a celebrity, or both.

4. The advertising method of claim 1, wherein the advertisements include trademarks for the products or providers thereof.

5. The advertising method of claim 1, further comprising placing a trademark for the branded entity on one or more of the cards.

6. The advertising method of claim 5, wherein each of the cards has a back side and a front side, the step of placing a trademark comprises placing the trademark on the back sides of all or substantially all of the cards, and the step of placing advertisements comprises placing advertisements on the front sides of some or all of the cards.

7. The advertising method of claim 1, wherein the cards have hierarchical values and the advertisements have prices, further comprising correlating the advertisement prices to the hierarchical values of the cards so that the advertising price for the advertisement on a higher-value one of the cards is higher than on a lower-value one of the cards.

8. The advertising method of claim 7, wherein the correlation between the advertisement prices and the hierarchical card values is based on groups of the cards so that the advertising price for the advertisements on a higher-value group of the cards is higher than on a lower-value group of the cards.

9. The advertising method of claim 1, wherein the cards have hierarchical values and the products have price ranges, further comprising generally correlating the product price ranges to the hierarchical values of the cards so that generally the price range for the product on a higher-value one of the cards is higher than on a lower-value one of the cards.

10. The advertising method of claim 9, wherein the general correlation between the product price ranges and the hierarchical card values is based on groups of the cards so that the price ranges for the products on a higher-value group of the cards is higher than on a lower-value group of the cards.

11. The advertising method of claim 1, wherein the cards have hierarchical values and suits, further comprising correlating at least one category of the products to at least one of the card values or suits so that all the advertisements for all the products within the product category are placed on the cards having the correlated value or suit.

12. The advertising method of claim 11, wherein the product category is all brands of one type of the products or all of the products sold under one brand.

13. The advertising method of claim 1, further comprising providing at least one prize card with the playing cards, wherein the prize card includes win/lose indicia that indicates if a prize has been won.

14. The advertising method of claim 13, wherein the prize is one of the products of one of the advertisements on the playing cards.

15. The advertising method of claim 1, further comprising providing a themed building compound including a casino at which the playing cards are used and a retail outlet at which the products of the advertisements on the playing cards are sold.

16. A deck of the playing cards with the advertisements provided for use in the advertising method of claim 1.

17. An method of advertising to patrons of a casino, comprising:
providing a deck of playing cards, wherein the cards have hierarchical values and suits, and wherein each of the cards has a back side and a front side;
placing a trademark for a casino on the back sides of all or substantially all of the cards;
placing advertisements on the front sides of some or all of the cards, wherein the advertisements are for products or providers thereof of common purchasing interest to patrons of the casino, wherein the advertisements have prices and include trademarks for the products or providers thereof, and wherein the products have prices;
correlating at least one category of the products to at least one of the card values or suits so that all the advertisements for all the products within the product category are placed on the cards having the correlated value or suit;
correlating the advertisement prices to the hierarchical values of the cards so that the advertising price for the advertisement on a higher-value one of the cards is higher than on a lower-value one of the cards; and
generally correlating the product price ranges to the hierarchical values of the cards so that generally the price range for the product on a higher-value one of the cards is higher than on a lower-value one of the cards.

18. The advertising method of claim 17, wherein the correlation between the advertisement prices and the hierarchical card values is based on groups of the cards so that the advertising price for the advertisements on a higher-value group of the cards is higher than on a lower-value group of the cards.

19. The advertising method of claim 17, wherein the general correlation between the product price ranges and the hierarchical card values is based on groups of the cards so that the price range for the products on a higher-value group of the cards is higher than on a lower-value group of the cards.

20. The advertising method of claim 17, wherein the product category is all brands of one type of the products or all of the products sold under one brand.

21. The advertising method of claim 17, further comprising providing at least one prize card with the playing cards, wherein the prize card includes win/lose indicia that indicates if a prize has been won, and wherein the prize is one of the products of one of the advertisements on the playing cards.

22. The advertising method of claim 17, further comprising providing a themed building compound including a casino at which the playing cards are used and a retail outlet at which the products of the advertisements on the playing cards are sold.

23. The deck of the playing cards with the advertisements provided for use in the advertising method of claim 17.
